(19) United States
(12) Patent Application Publication
(10) Pub. No.: US 2025/0051928 A1
(43) Pub. Date: Feb. 13, 2025

(54) COLD SPRAY SYSTEMS AND METHODS FOR COATING CAST MATERIALS

(71) Applicant: Novelis Inc., Atlanta, GA (US)

(72) Inventors: Niloofar Nabili TEHRANI, Atlanta, GA (US); Sarmistha DAS, Kennesaw, GA (US); Suzanne HAUPT, Kennesaw, GA (US); Stewart Edward HICKEY, Dallas, GA (US); Sazol Kumar DAS, Acworth, GA (US); Rajeev G. KAMAT, Marietta, GA (US); David GAENSBAUER, Burlington, VT (US); Monica KAPOOR, Acworth, GA (US)

(73) Assignee: Novelis Inc., Atlanta, GA (US)

(21) Appl. No.: 18/722,840

(22) PCT Filed: Jan. 25, 2023
(86) PCT No.: PCT/US2023/061205

§ 371 Date: Jun. 21, 2024

Related U.S. Application Data
(60) Provisional application No. 63/267,128, filed on Jan. 25, 2022.

(51) Int. Cl. C23C 24/08

(52) U.S. Cl. CPC C23C 24/087

(57) ABSTRACT

A method of processing a metal substrate may include receiving the metal substrate and additively depositing metal particles on the metal substrate by cold spraying the metal particles to generate a cold spray coating adhered to the metal substrate. The method optionally may include rolling the metal substrate after depositing the metal particles to form the cold spray coating or before depositing the metal particles to form the cold spray coating. The method optionally may include heating the metal substrate before cold spraying. A metal processing system may include a cold spray system for additively deposing the metal particles on the metal substrate, and at least one piece of equipment for further processing the metal substrate.

### REFERENCE TO RELATED APPLICATION

This application claims the benefit of U.S. Provisional Patent Application No. 63/267,128, filed on Jan. 25, 2022, and entitled COLD SPRAY SYSTEMS AND METHODS FOR COATING CAST MATERIALS, the content of which is hereby incorporated by reference in its entirety.

### FIELD OF THE INVENTION

This application relates to metallurgy generally and more specifically to systems and methods for applying a coating on cast materials.

### BACKGROUND

Continuous casting of metals such as aluminum or aluminum alloys often results in cast products with surface defects that are hard to remove or mask with conventional technology, and the presence of such surface defects limits the potential uses for such products. Moreover, removing such surface defects via scalping or surface removal incurs process losses both from a time and cost perspective. Thus, techniques for making continuously cast materials with improved surfaces are lacking.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a method of processing a metal substrate includes additively depositing metal particles on the metal substrate by cold spraying the metal particles to generate a cold spray coating adhered to the metal substrate. The method includes rolling the metal substrate having the cold spray coating with a rolling mill.

According to various embodiments, a method of processing a metal substrate includes rolling the metal substrate with a rolling mill and additively depositing metal particles on the rolled metal substrate by cold spraying the metal particles to generate a cold spray coating adhered to the rolled metal substrate.

According to some embodiments, a method of processing a heated metal substrate includes receiving the heated metal substrate at a cold spray system and additively depositing metal particles on the metal substrate by cold spraying the metal particles to generate a cold spray coating adhered to the metal substrate.

According to various embodiments, a metal processing system includes a cold spray system for additively depositing metal particles on a metal substrate by cold spraying the metal particles to generate a cold spray coating adhered to the metal substrate. The metal processing system may include a rolling mill upstream or downstream from the cold spray system.

According to certain embodiments, a metal processing system includes a heater for heating a metal substrate and a cold spray system downstream from the heater for additively depositing metal particles on the heated metal substrate by cold spraying the metal particles to generate a cold spray coating adhered to the metal substrate.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a metal processing system with a cold spray system according to embodiments.

FIG. 2 illustrates a portion of the metal substrate being processed by the metal processing system of FIG. 1 and taken from box 2 in FIG. 1.

FIG. 3 illustrates a process of cold spraying a metal substrate with the metal processing system of FIG. 1 according to embodiments.

FIG. 4 illustrates another process of cold spraying a metal substrate with the metal processing system of FIG. 1 according to embodiments.

FIG. 5 illustrates a method of processing a metal substrate according to embodiments.

FIG. 6 illustrates another method of processing a metal substrate according to embodiments.

FIG. 7 is an image of a metal substrate with a cold spray coating according to embodiments.

FIG. 8 is an image of the metal substrate with the cold spray coating of FIG. 7 after rolling according to embodiments.

FIG. 9 is an image of a metal substrate with a cold spray coating according to embodiments.

FIG. 10 is an image of a metal substrate with a cold spray coating according to embodiments.

FIG. 11 is an image of a metal substrate with a cold spray coating according to embodiments.

FIG. 12 is an image of a metal substrate with a cold spray coating according to embodiments.

FIG. 13 is another image of the metal substrate of FIG. 11 after rolling according to embodiments.

FIG. 14 is a chart illustrating surface roughness of metal substrates with cold spray coatings after rolling according to embodiments.

FIG. 15 is a chart illustrating bend angles of metal substrates with cold spray coatings after rolling according to embodiments.

FIG. 16 is an image of intergranular corrosion in a metal substrate without a cold spray coating after 24 hours and after rolling.

FIG. 17 is an image of intergranular corrosion in a metal substrate with a cold spray coating after 24 hours after rolling according to embodiments.

FIG. 18 is an image of intergranular corrosion in the metal substrate of FIG. 16 after 48 hours after rolling.

FIG. 19 is an image of intergranular corrosion in the metal substrate of FIG. 17 after 48 hours after exposure.

FIGS. 20A-C are images of metal substrates with cold spray coatings according to embodiments.

FIG. 21 illustrates a metal substrate with a cold spray coating according to embodiments compared to a metal substrate without a cold spray coating.

FIG. 22 illustrates a metal substrate with a cold spray coating according to embodiments compared to a metal substrate without a cold spray coating.

FIGS. 23A-B illustrate corrosion of a metal substrate with a cold spray coating according to embodiments compared to corrosion a metal substrate without a cold spray coating.

### DETAILED DESCRIPTION

Described herein are cold spray systems and methods for forming a cold spray coating on a metal substrate, as well as metal products with a cold spray coating. While the systems and methods described herein can be used with any metal, they may be especially useful with aluminum or aluminum alloys. Advantageously, the cold spray coating may be deposited onto the metal substrate during metal processing, such as after continuous casting, after direct chill casting, before rolling, after rolling, etc. In some aspects, cold spray coatings applied on a heated surface may create an interface with mechanical and/or chemical bonding to provide continuous protection for the metal product in service, which may be similar to products formed using “fusion casting,” which can be also referred to by the trade name FUSION™ (Novelis, Inc., Atlanta, US), and is described, for example, in U.S. Pat. No. 7,472,740, the contents of which are incorporated herein by reference. In various embodiments, the cold spray coating may conceal exudates and/or other defects on a surface of the metal substrate without deterioration of mechanical properties, which may allow for the metal substrate to be used in consumer-facing products, exterior products, and/or other high-quality products (referred to herein as “class A” products). In some embodiments, the cold spray coating may improve properties of the metal substrate, including but not limited to improving a surface color of the metal substrate, bendability, and/or corrosion resistance. The cold spray coating may be applied to products such as direct chill or continuously cast products to increase productivity by avoiding or minimizing scalping, improving the near surface microstructure, and/or improving final gauge properties. Various other benefits and advantages may be realized with the systems and methods provided herein, and the aforementioned advantages should not be considered limiting.

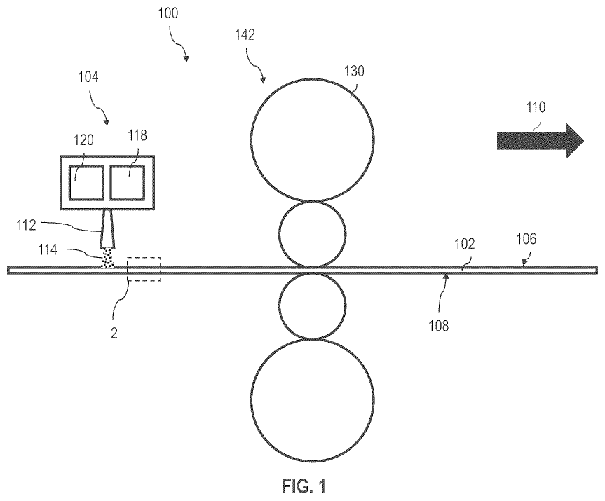

FIGS. 1-4 illustrates an example of a metal processing system 100 for processing a metal substrate 102 and that includes a cold spray system 104 according to various embodiments. In certain embodiments, and as discussed in detail below, in addition to the cold spray system 104, the metal processing system 100 may include one or more additional systems or equipment 142 for further processing the metal substrate 102.

As illustrated in FIG. 1, the metal substrate 102 includes opposing surfaces 106, 108, and in the embodiment of FIG. 1, is being processed in a processing (or casting) direction 110. The metal substrate 102 may be various materials including but not limited to aluminum, aluminum alloys, magnesium, magnesium-based materials, magnesium alloys, magnesium composites, titanium, titanium-based materials, titanium alloys, copper, copper-based materials, composites, sheets used in composites, or any other suitable metal, non-metal, or combination of materials. Monolithic as well as non-monolithic, such as roll-bonded materials, cladded alloys, clad layers, composite materials, such as but not limited to carbon fiber-containing materials, or various other materials may also be useful with the methods and products described herein. In certain embodiments, the metal substrate 102 is an aluminum alloy such as a 1xxx series aluminum alloy, a 2xxx series aluminum alloy, a 3xxx series aluminum alloy, a 4xxx series aluminum alloy, a 5xxx series aluminum alloy, a 6xxx series aluminum alloy, a 7xxx series aluminum alloy, or an 8xxx series aluminum alloy. In one non-limiting example, the metal substrate 102 is at least one of a 5xxx series aluminum alloy, a 6xxx series aluminum alloy, or a 7xxx series aluminum alloy.

By way of non-limiting example, exemplary 1xxx alloys for use in the methods and products described herein can include AA1100, AA1100A, AA1200, AA1200A, AA1300, AA1110, AA1120, AA1230, AA1230A, AA1235, AA1435, AA1145, AA1345, AA1445, AA1150, AA1350, AA1350A, AA1450, AA1370, AA1275, AA1185, AA1285, AA1385, AA1188, AA1190, AA1290, AA1193, AA1198, or AA1199.

Non-limiting exemplary 2xxx series alloys for use in the methods and products described herein can include AA2001, A2002, AA2004, AA2005, AA2006, AA2007, AA2007A, AA2007B, AA2008, AA2009, AA2010, AA2011, AA2011A, AA2111, AA2111A, AA2111B, AA2012, AA2013, AA2014, AA2014A, AA2214, AA2015, AA2016, AA2017, AA2017A, AA2117, AA2018, AA2218, AA2618, AA2618A, AA2219, AA2319, AA2419, AA2519, AA2021, AA2022, AA2023, AA2024, AA2024A, AA2124, AA2224, AA2224A, AA2324, AA2424, AA2524, AA2624, AA2724, AA2824, AA2025, AA2026, AA2027, AA2028, AA2028A, AA2028B, AA2028C, AA2029, AA2030, AA2031, AA2032, AA2034, AA2036, AA2037, AA2038, AA2039, AA2139, AA2040, AA2041, AA2044, AA2045, AA2050, AA2055, AA2056, AA2060, AA2065, AA2070, AA2076, AA2090, AA2091, AA2094, AA2095, AA2195, AA2295, AA2196, AA2296, AA2097, AA2197, AA2297, AA2397, AA2098, AA2198, AA2099, or AA2199.

Non-limiting exemplary 3xxx series alloys for use in the methods and products described herein can include AA3002, AA3102, AA3003, AA3103, AA3103A, AA3103B, AA3203, AA3403, AA3004, AA3004A, AA3104, AA3204, AA3304, AA3005, AA3005A, AA3105, AA3105A, AA3105B, AA3007, AA3107, AA3207, AA3207A, AA3307, AA3009, AA3010, AA3110, AA3011, AA3012, AA3012A, AA3013, AA3014, AA3015, AA3016, AA3017, AA3019, AA3020, AA3021, AA3025, AA3026, AA3030, AA3130, or AA3065.

Non-limiting exemplary 4xxx series alloys for use in the methods and products described herein can include AA4004, AA4104, AA4006, AA4007, AA4008, AA4009, AA4010, AA4013, AA4014, AA4015, AA4015A, AA4115, AA4016, AA4017, AA4018, AA4019, AA4020, AA4021, AA4026, AA4032, AA4043, AA4043A, AA4143, AA4343, AA4643, AA4943, AA4044, AA4045, AA4145, AA4145A, AA4046, AA4047, AA4047A, or AA4147.

Non-limiting exemplary 5xxx series alloys for use in the methods and products described herein can include AA5182, AA5183, AA5005, AA5005A, AA5205, AA5305, AA5505, AA5605, AA5006, AA5106, AA5010, AA5110, AA5110A, AA5210, AA5310, AA5016, AA5017, AA5018, AA5018A, AA5019, AA5019A, AA5119, AA5119A, AA5021, AA5022, AA5023, AA5024, AA5026, AA5027, AA5028, AA5040, AA5140, AA5041, AA5042, AA5043, AA5049, AA5149, AA5249, AA5349, AA5449, AA5449A, AA5050, AA5050A, AA5050C, AA5150, AA5051, AA5051A, AA5151, AA5251, AA5251A, AA5351, AA5451, AA5052, AA5252, AA5352, AA5154, AA5154A, AA5154B, AA5154C, AA5254, AA5354, AA5454, AA5554, AA5654, AA5654A, AA5754, AA5854, AA5954, AA5056, AA5356, AA5356A, AA5456, AA5456A, AA5456B, AA5556, AA5556A, AA5556B, AA5556C, AA5257, AA5457, AA5557, AA5657, AA5058, AA5059, AA5070, AA5180, AA5180A, AA5082, AA5182, AA5083, AA5183, AA5183A, AA5283, AA5283A, AA5283B, AA5383, AA5483, AA5086, AA5186, AA5087, AA5187, or AA5088.

Non-limiting exemplary 6xxx series alloys for use in the methods and products described herein can include AA6101, AA6101A, AA6101B, AA6201, AA6201A, AA6401, AA6501, AA6002, AA6003, AA6103, AA6005, AA6005A, AA6005B, AA6005C, AA6105, AA6205, AA6305, AA6006, AA6106, AA6206, AA6306, AA6008, AA6009, AA6010, AA6110, AA6110A, AA6011, AA6111, AA6012, AA6012A, AA6013, AA6113, AA6014, AA6015, AA6016, AA6016A, AA6116, AA6018, AA6019, AA6020, AA6021, AA6022, AA6023, AA6024, AA6025, AA6026, AA6027, AA6028, AA6031, AA6032, AA6033, AA6040, AA6041, AA6042, AA6043, AA6151, AA6351, AA6351A, AA6451, AA6951, AA6053, AA6055, AA6056, AA6156, AA6060, AA6160, AA6260, AA6360, AA6460, AA6460B, AA6560, AA6660, AA6061, AA6061A, AA6261, AA6361, AA6162, AA6262, AA6262A, AA6063, AA6063A, AA6463, AA6463A, AA6763, A6963, AA6064, AA6064A, AA6065, AA6066, AA6068, AA6069, AA6070, AA6081, AA6181, AA6181A, AA6082, AA6082A, AA6182, AA6091, or AA6092.

Non-limiting exemplary 7xxx series alloys for use in the methods and products described herein can include AA7011, AA7019, AA7020, AA7021, AA7039, AA7072, AA7075, AA7085, AA7108, AA7108A, AA7015, AA7017, AA7018, AA7019A, AA7024, AA7025, AA7028, AA7030, AA7031, AA7033, AA7035, AA7035A, AA7046, AA7046A, AA7003, AA7004, AA7005, AA7009, AA7010, AA7011, AA7012, AA7014, AA7016, AA7116, AA7122, AA7023, AA7026, AA7029, AA7129, AA7229, AA7032, AA7033, AA7034, AA7036, AA7136, AA7037, AA7040, AA7140, AA7041, AA7049, AA7049A, AA7149, 7204, AA7249, AA7349, AA7449, AA7050, AA7050A, AA7150, AA7250, AA7055, AA7155, AA7255, AA7056, AA7060, AA7064, AA7065, AA7068, AA7168, AA7175, AA7475, AA7076, AA7178, AA7278, AA7278A, AA7081, AA7181, AA7185, AA7090, AA7093, AA7095, or AA7099.

Non-limiting exemplary 8xxx series alloys for use in the methods and products described herein can include AA8005, AA8006, AA8007, AA8008, AA8010, AA8011, AA8011A, AA8111, AA8211, AA8112, AA8014, AA8015, AA8016, AA8017, AA8018, AA8019, AA8021, AA8021A, AA8021B, AA8022, AA8023, AA8024, AA8025, AA8026, AA8030, AA8130, AA8040, AA8050, AA8150, AA8076, AA8076A, AA8176, AA8077, AA8177, AA8079, AA8090, AA8091, or AA8093.

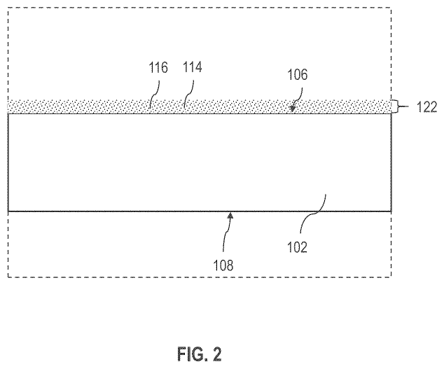

In the embodiment illustrated in FIGS. 1 and 2, the metal substrate 102 is a continuously cast metal sheet; however, in other embodiments, the metal substrate 102 may be other types of substrates as desired, including but not limited to an ingot, billet, other cast product, plate, shate, sheet, and/or other rolled product as desired. In one non-limiting example, the metal substrate 102 is an ingot formed via direct chill casting.

The cold spray system 104 generally includes a nozzle 112 for depositing particles 114 that form a cold spray coating 116 (see FIG. 2) having a thickness 122 on at least one surface of the metal substrate 102. In the embodiment illustrated, the cold spray system 104 deposits the particles 114 on the surface 106 such that the cold spray coating 116 is on the surface 106; however, in other embodiments, the cold spray system 104 may deposit the particles 114 on the surface 108 or on both of the surfaces 106, 108 as desired. The cold spray system 104 may also include a particle (or powder) feeder 118 for receiving a supply of the particles 114 and a heater 120 for heating a gas that is used to accelerate the particles 114 onto the metal substrate 102.

The particle feeder 118 may receive the supply of particles 114 and provides the particles 114 to the nozzle 112. In certain embodiments, the particle feeder 118 is controlled to control a rate at which the particles 114 are supplied to the nozzle 112, which may control a rate at which the particles 114 are cold sprayed onto the metal substrate 102 and the thickness 122 of the cold spray coating 116. The particles 114 may be various types of powdered materials as desired suitable for cold spraying, and in certain embodiments, the particles 114 are a metal including but not limited to aluminum alloys. In one non-limiting example, the particles 114 are a 6xxx series aluminum alloy. In one non-limiting example, at least one characteristic or property of the metal used as the particles 114 may be different from the metal of the metal substrate 102. In one non-limiting example, the metal used as the particles 114 may have a higher hardness than a hardness of the metal of the metal substrate 102. The particles 114 may have various diameters as desired, and in certain embodiments, the diameters may be from greater than 0 μm to about 100 μm, such as from greater than 0 μm to about 50 μm, such as from about 5 μm to about 50 μm. In some embodiments, the type of material (e.g., a particular aluminum alloy) used as the particles 114 and/or a size of the particles 114 may be controlled to control the thickness 122 of the cold spray coating 116.

The heater 120 may be various suitable devices or mechanisms for receiving the gas and heating the gas to a desired temperature. The gas may be various types of gases suitable for cold spraying as desired, including but not limited to air, nitrogen, helium, and/or other gases or combination of gases. In some embodiments, a pressure of the gas may be controlled such that the cold spray system 104 is a high-pressure cold spray system or a low-pressure cold spray system. In certain embodiments, the heater 120 may be controlled to control the temperature to which the gas is heated.

The nozzle 112 may be various types of nozzles suitable for spraying the particles 114 onto the metal substrate 102 during a cold spraying process. During the cold spraying process, the nozzle 112 is scanned or traversed over the metal substrate 102 to spray the particles 114 on the metal substrate 102 and to form the cold spray coating 116, and the nozzle 112 may include various deposition controls for controlling the thickness 122 of the cold spray coating 116. Deposition controls of the nozzle 112 may include, but are not limited to, a distance between the nozzle 112 and the metal substrate 102, a traverse direction (e.g., parallel to the casting direction 110 or perpendicular to the casting direction 110), a linear speed, a number of passes over a given area on the metal substrate 102, and/or a scanning step (distance between adjacent passes).

During a cold spraying process, the particle feeder 118 supplies the particles 114 to the nozzle 112 and the heated gas from the heater 120 is provided to the nozzle 112 such that the particles 114 are accelerated to high velocities and then sprayed onto the metal substrate 102. Upon impact with the metal substrate 102, the particles 114 undergo adiabatic heating and plastically deform, causing them to mechanically adhere to metal substrate 102 to form the cold spray coating 116. In certain embodiments, and as discussed in detail below, the metal substrate 102 optionally may be heated prior to the cold spraying process, and cold spraying the heated metal substrate 102 may create an interface with both mechanical and chemical bonding.

As mentioned, one or more control parameters of the cold spray system 104 may be controlled such that the cold spray coating 116 has a thickness 122 that covers exudates and/or other defects on the surface of the metal substrate 102. The thickness 122 illustrated in FIG. 2 has been dramatized for ease of viewing and is not intended to infer a particular thickness 122 relative to the metal substrate 102. In one non-limiting example, the cold spray system 104 may be controlled such that the thickness 122 of the cold spray coating 116 is from about 20 μm to about 300 μm, such as from about 30 μm to about 200 μm, such as from about 30 μm to about 150 μm, such as from about 30 μm to about 100 μm, or such as from about 60 μm to about 100 μm. In some embodiments, the cold spray system 104 is controlled such that the thickness 122 of the cold spray coating 116 is less than a thickness of the metal substrate 102. Non-limiting examples of the parameters of the cold spray system 104 that may be controlled during processing include, but are not limited to, the type of gas used to accelerate the particles 114, the gas pressure used to accelerate the particles, the temperature that the heater 120 heats the gas, the type of material used as the particles 114, the diameter or size of the particles 114, the feed rate of the particles 114 from the particle feeder 118, the type of nozzle 112, the angle of the nozzle 112 relative to the surface of the metal substrate 102, the distance between the nozzle 112 and the metal substrate 102, the linear speed of the nozzle 112 over the metal substrate 102, the traverse direction of the nozzle 112 over the metal substrate 102, the number of passes of the nozzle 112, and/or the scanning step.

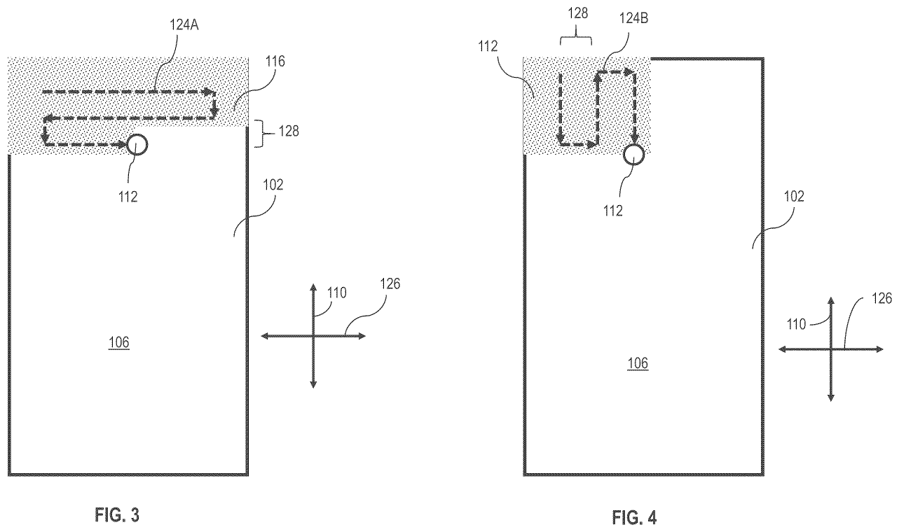

FIGS. 3 and 4 illustrate two non-limiting examples of patterns of cold spraying the particles 114 on the metal substrate 102 using the cold spray system 104 to form the cold spray coating 116 on the surface 106. FIG. 3 illustrates a first spraying path 124A of the nozzle 112, and FIG. 4 illustrates a second spraying path 124B of the nozzle 112. In FIG. 3, the first spraying path 124A is in a transverse direction that is perpendicular to the casting direction 110 (or in a lateral direction 126 along the surface 106) and a scanning step 128 is a first distance (e.g., 1 mm). In FIG. 4, the second spraying path 124B is parallel to the casting direction 110 and the scanning step 128 is a second distance that is greater than the first distance (e.g., 3 mm). Various other spray patterns and/or spray paths may be utilized as desired by the cold spray system 104 to provide the cold spray coating 116 having the desired thickness 122.

Referring to FIG. 1, in certain embodiments, in addition to the cold spray system 104, the metal processing system 100 optionally includes the at least one additional piece of processing equipment 142. In the embodiment illustrated, the additional piece of processing equipment 142 is a work stand 130 of a rolling mill; however, in other embodiments, additional types of processing equipment may be utilized with the metal processing system 100 as desired. Non-limiting examples of processing equipment may include, but are not limited to, equipment for casting the metal substrate 102, equipment for homogenization, equipment for hot rolling, equipment for cold rolling, equipment for solution heat treatment, equipment for aging, equipment for coiling, equipment for shearing, equipment for stamping, equipment for forming, and/or equipment for roll forming. Moreover, while the equipment 142 is illustrated as downstream from the cold spray system 104 in the casting direction 110, it need not be in other embodiments, and in some optional embodiments, the cold spray system 104 may be provided between two pieces of equipment 142. As one non-limiting example, the cold spray system 104 may be provided immediately downstream from a heater or furnace as a first piece of equipment 142 and immediately upstream from a work stand of a rolling mill as a second piece of equipment. In certain embodiments, the cold spray system 104 may be at various locations relative to other equipment such that the cold spray system 104 deposits the particles 114 for the cold spray coating 116 on the metal substrate 102 while the metal substrate 102 is still warm from upstream processes. In such embodiments, the metal substrate 102 need not be heated by a separate heater. In other words, the metal substrate 102 may be a warm, heated, or hot material suitable for forming the cold spray coating 116 by heating and/or by utilizing residual heat from an upstream operation. Non-limiting examples of such upstream operations may include, but are not limited to, casting, warm or hot rolling, inter-annealing, continuous annealing solution heat treatment, combinations thereof, and/or other upstream operations as desired.

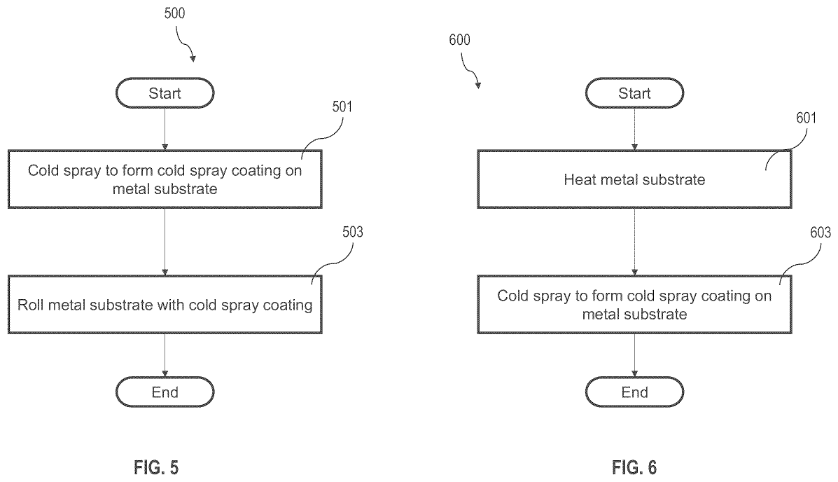

FIGS. 5 and 6 illustrate two metal processing processes in which cold spraying with the cold spray system 104 is performed in conjunction with at least one additional metal processing technique. FIG. 5 illustrates a non-limiting example of a metal processing process 500 according to various embodiments that includes cold spraying and rolling, and FIG. 6 illustrates a non-limiting example of a metal processing process 600 according to embodiments that includes heating and cold spraying.

Referring to FIG. 5, in a block 501, the process 500 includes receiving the metal substrate 102 and cold spraying the metal substrate 102 using the cold spray system 104 such that the cold spray coating 116 is formed on at least one of the surfaces of the metal substrate 102 (e.g., the surface 106). In certain embodiments, block 501 includes controlling the cold spray system 104 to control the thickness 122 of the cold spray coating 116. In such embodiments, block 501 may include controlling the cold spray system 104 such that the cold spray coating 116 includes a thickness 122 sufficient to cover exudates and/or other defects on the surface of the metal substrate 102. In some non-limiting embodiments, controlling the cold spray system 104 includes controlling the cold spray system 104 such that the thickness 122 is from about 20 μm to about 300 μm, such as from about 30 μm to about 200 μm, such as from about 30 μm to about 150 μm, such as from about 30 μm to about 100 μm, or such as from about 60 μm to about 100 μm. Optionally, controlling the cold spray system 104 in block 501 may include, but is not limited to, controlling the type of gas used to accelerate the particles 114, the gas pressure used to accelerate the particles, the temperature that the heater 120 heats the gas, the type of material used as the particles 114, the diameter or size of the particles 114, the feed rate of the particles 114 from the particle feeder 118, the type of nozzle 112, the angle of the nozzle 112 relative to the surface of the metal substrate 102, the distance between the nozzle 112 and the metal substrate 102, the linear speed of the nozzle 112 over the metal substrate 102, the traverse direction of the nozzle 112 over the metal substrate 102, the number of passes of the nozzle 112, and/or the scanning step.

In a block 503, the process includes rolling the metal substrate 102 with the cold spray coating 116 using a rolling mill. In one non-limiting embodiment, block 503 may include rolling using a hot rolling mill to form a hot rolled plate, a hot rolled shate or a hot rolled sheet having a gauge between 3 mm and 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between). As another non-limiting embodiment, block 503 may include rolling using a cold rolling mill to form a cold rolled sheet having a gauge between about 0.5 to 10 mm, e.g., between about 0.7 to 6.5 mm. Optionally, the cold rolled product can have a gauge of 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, or 10.0 mm.

Optionally, the process 500 may include one or more processing steps or techniques before cold spraying in block 501 and/or after rolling in block 503. In one non-limiting example, the process may include continuously casting the metal substrate 102 before cold spraying or direct chill casting an ingot as the metal substrate 102 before cold spraying. In another non-limiting example, the process may include rolling the metal substrate 102 before cold spraying and/or heating or homogenizing the metal substrate 102 before cold spraying.

In certain embodiments, in addition to concealing exudates with the cold spray coating 116, rolling the metal substrate 102 after the application of the cold spray coating 116 per the process 500 may improve adhesion between the particles 114 forming the cold spray coating 116 as well as adhesion between the particles 114 and the metal substrate 102. Rolling the metal substrate 102 after the application of the cold spray coating 116 may also minimize or reduce porosities in the cold spray coating 116, which may improve the cold spray coating 116 properties for subsequent processing and/or as a finished product.

Referring to FIG. 6, in a block 601, the process 600 includes heating the metal substrate 102 and/or receiving a heated metal substrate 102. Heating of the metal substrate 102 and/or receiving the heated metal substrate 102 in block 601 may include using residual heat from an upstream operation or equipment (and/or receiving a metal substrate 102 that is heated from residual heat from an upstream operation), and/or heating of the metal substrate 102 in block 601 may include using a heater to heat the metal substrate. As non-limiting examples, upstream processes such as casting, rolling, and/or continuous annealing solution heat treatment may provide residual heat in the metal substrate 102 suitable heating the metal substrate 102 for cold spraying. Additionally, or alternatively, a dedicated heater or heating system may heat the metal substrate 102 before cold spraying. In one non-limiting example, heating the metal substrate 102 includes heating the metal substrate 102 to a temperature ranging from about 400° C. to about 500° C., such as about 400° C., about 410° C., about 420° C., about 430° C., about 440° C., about 450° C., about 460° C., about 470° C., about 480° C., about 490° C., or about 500° C. In another non-limiting example, heating the metal substrate 102 optionally includes heating the metal substrate 102 such that the temperature of the metal substrate 102 after cold spraying is from about 250° C. to about 400° C., such as about 250° C., about 260° C., about 270° C., about 280° C., about 290° C., about 300° C., about 310° C., about 320° C., about 330° C., about 340° C., about 350° C., about 360° C., about 370° C., about 380° C., about 390° C., or about 400° C.

After the heating performed in block 601, the process 600 includes cold spraying the heated metal substrate 102 in a block 603. Block 603 is substantially similar to block 501 of the process 500. Similar to the process 500, the process 600 optionally includes one or more additional processing steps before block 601 and/or after block 604.

In certain embodiments, in addition to concealing exudates with the cold spray coating 116, heating the metal substrate 102 prior to the application of the cold spray coating 116 per the process 600 may create an interface with chemical and/or mechanical bonding between the cold spray coating 116 and the metal substrate 102. Such an interface with a chemical and mechanical bond may provide improved protection to the metal substrate 102 in service (e.g., as a finished product).

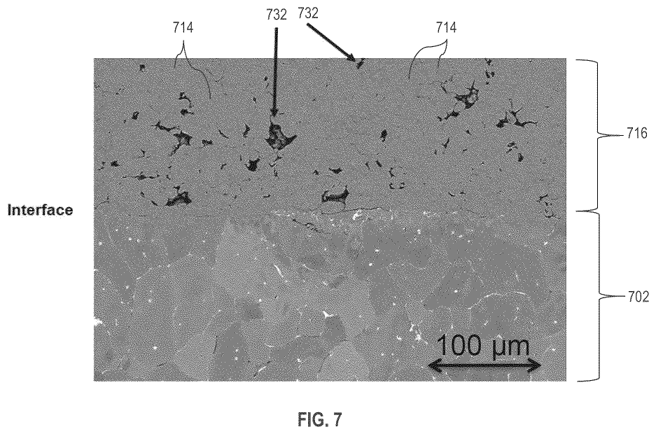

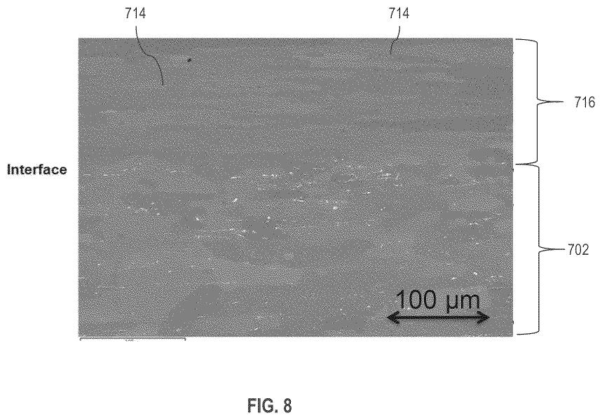

FIGS. 7 and 8 are magnified images depicting an AA6111 alloy metal substrate 702 having a cold spray coating 716 formed with AA6061 alloy particles 714. FIG. 7 illustrates the metal substrate 702 with the cold spray coating 716 before rolling, and FIG. 8 illustrates the metal substrate 702 with the cold spray coating 716 after rolling and after heat treatment. As illustrated in FIG. 7, without rolling, the cold spray coating 716 may include porosities 734 of various dimensions between particles 714 forming the cold spray coating 716. By comparison and as illustrated in FIG. 8, rolling and heat treatment of the metal substrate 702 with the cold spray coating 716 may remove or substantially remove such porosities 734, which may improve the properties of the cold spray coating 716.

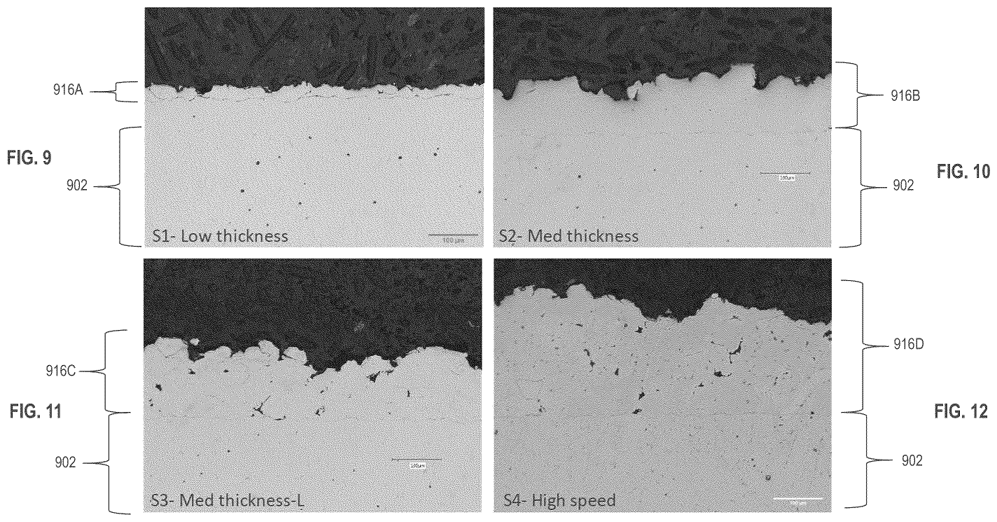

FIGS. 9-19 are images and charts showing properties of metal substrates with cold spray coatings according to methods described herein. In these examples, Samples 1-4 (herein abbreviated as “S1,” “S2,” “S3,” and “S4”, respectively) each included a continuously cast AA6111 alloy metal substrate 902 and a cold spray coating formed with AA6061 alloy particles on one side of the metal substrate 902. An opposite side of the metal substrate 902 was not cold sprayed. Each of S1-4 were also heated such that the temperature of the metal substrates prior to cold spraying was 420° C.-500° C. A control substrate 938 in these examples (hereinafter “Control”) was an as-cast AA6111 alloy metal substrate.

In S1, a cold spray coating 916A was applied to the metal substrate 902 by moving the nozzle of the cold spray system in the direction perpendicular to the casting direction and at a linear speed of 750 mm/s, the scanning step was 1 mm, and the particle feeder speed was 1 RPM. FIG. 9 illustrates the cold spray coating 916A on the metal substrate 902 and before any rolling. In this embodiment, the thickness 122 of the cold spray coating 916A ranged from 18 μm to 43 μm and had an average thickness of 33 μm.

For S2, a cold spray coating 916B was applied to the metal substrate 902 by moving the nozzle of the cold spray system in the direction perpendicular to the casting direction and at a linear speed of 250 mm/s, the scanning step was 1 mm, and the particle feeder speed was 1.4 RPM. FIG. 10 illustrates the cold spray coating 916B on the metal substrate 902 and before any rolling. In this embodiment, the thickness 122 of the cold spray coating 916B ranged from 72 μm to 172 μm and had an average thickness of 126 μm.

For S3, a cold spray coating 916C was applied to the metal substrate 902 by moving the nozzle of the cold spray system in the direction parallel to the casting direction and at a linear speed of 250 mm/s, the scanning step was 1 mm, and the particle feeder speed was 1.4 RPM. FIG. 11 illustrates the cold spray coating 916C on the metal substrate 902 and before any rolling. In this embodiment, the thickness 122 of the cold spray coating 916C ranged from 87 μm to 203 μm and had an average thickness of 149 μm.

In S4, a cold spray coating 916D was applied to the metal substrate 902 by moving the nozzle of the cold spray system in the direction parallel to the casting direction and at a linear speed of 150 mm/s, the scanning step was 3 mm, and the particle feeder speed was 4 RPM. FIG. 12 illustrates the cold spray coating 916D on the metal substrate 902 and before any rolling. In this embodiment, the thickness 122 of the cold spray coating 916D ranged from 120 μm to 293 μm and had an average thickness of 200 μm.

As illustrated by comparing FIGS. 9-12, the cold spray system controlled pursuant to S1 produced the cold spray coating 916A with the smallest thickness 122 while the cold spray system controlled pursuant to S4 produced the cold spray coating 916D with the largest thickness.

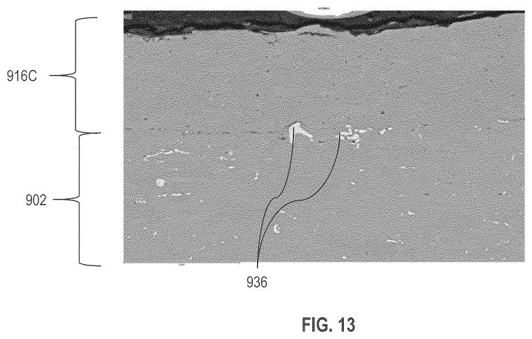

FIG. 13 illustrates S3 after rolling. As illustrated in this figure, exudates 936 at an interface between the cold spray coating 916C and the metal substrate 902 were covered and concealed by the cold spray coating 916C. Without the cold spray coating 916, the exudates 936 would have been present on an outer surface of the metal substrate 902 and require removal and/or limit uses of the metal substrate 902 to inner or structural applications.

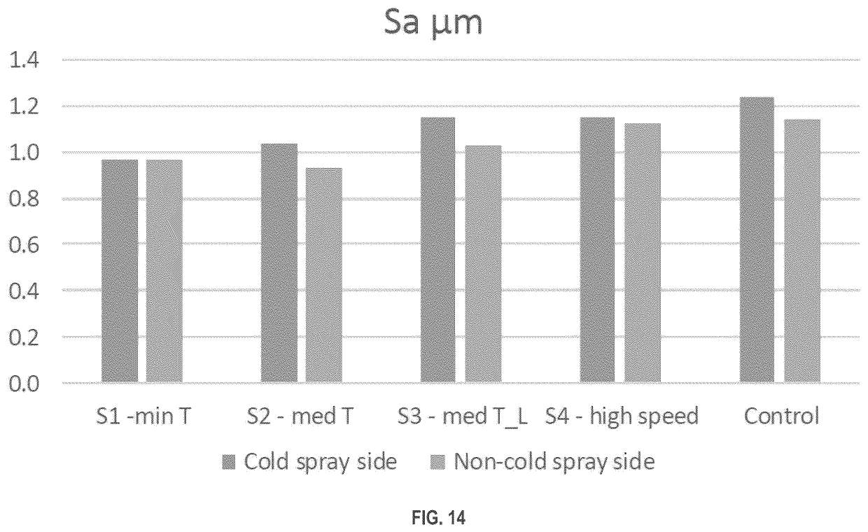

FIG. 14 is a chart illustrating the surface roughness (Sa) after rolling of S1-4 and compared to the Control. For each of S1-4 and the Control, the surface roughness was measured on both the cold spray side and the non-cold spray side. S1-S4 and the Control were also tested for material strength and elongation pursuant to ASTM B557, and the cold spray coatings of S1-S4 did not show significant impact on material strength or elongation. Such results indicate that the properties of the metal substrate were not deteriorated due to the cold spray coatings.

In certain embodiments, in addition to masking exudates and maintaining some properties of the metal substrates as illustrated in FIGS. 9-14, the cold spray coatings may improve properties of the coated metal substrates. As some non-limiting examples, the cold spray coatings may improve bendability, corrosion performance (e.g., corrosion resistance), and/or color quality.

As a non-limiting example, cold spray coatings described herein may be used on 5xxx series aluminum alloys, including but not limited to 5182 aluminum alloys, to improve surface color changes due to magnesium oxide formation after heat treatment or hot rolling of such alloys.

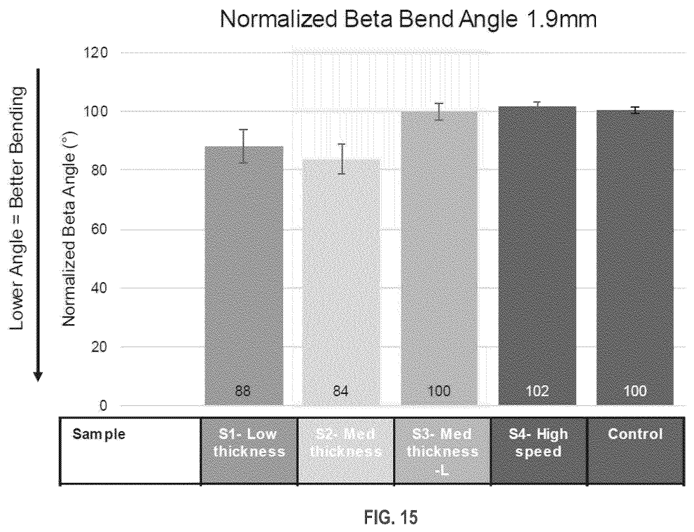

As another non-limiting example, FIG. 15 illustrates bend angles of S1-4 and the Control after rolling when tested according to VDA-238-100. As illustrated in FIG. 15, S1 (cold spray coating with minimum thickness) and S2 (cold spray coating with medium thickness applied perpendicular to the casting direction) both had improved bending performance compared to the Control.

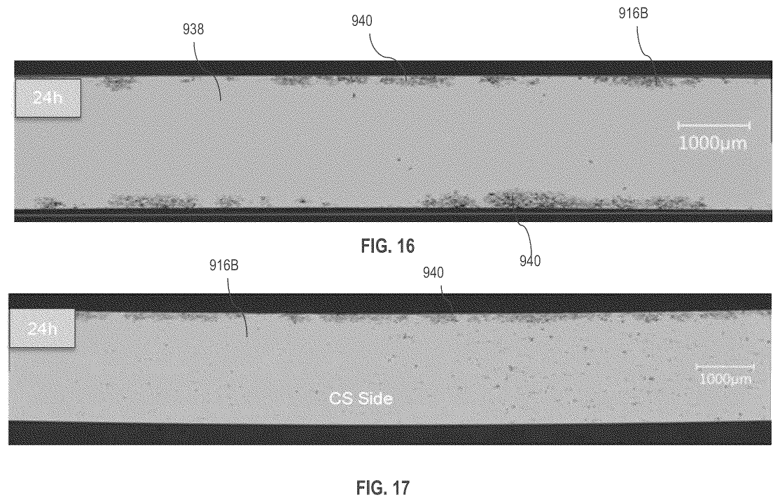

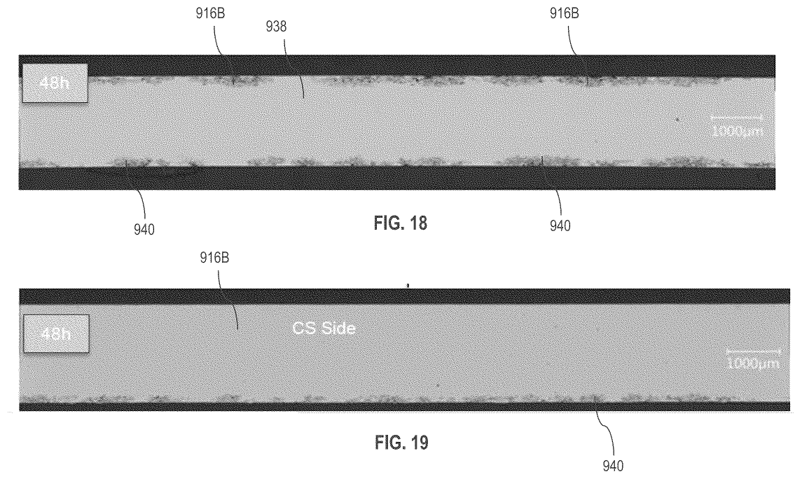

As a further non-limiting example, FIGS. 16-19 are top view images showing intergranular corrosion performance after exposure of: the Control to a chemical after 24 hours (FIG. 16); S2 to the same chemical after 24 hours (FIG. 17); the Control the same chemical after 48 hours (FIG. 18); and S2 to the same chemical after 48 hours (FIG. 19). FIGS. 16 and 18 illustrate intergranular corrosion 940 in the Control both after 24 hours and after 48 hours. By comparison, S2 had significantly reduced areas of intergranular corrosion 940, illustrating that the cold spray coating provided improved corrosion resistance compared to substrates without cold spray coatings.

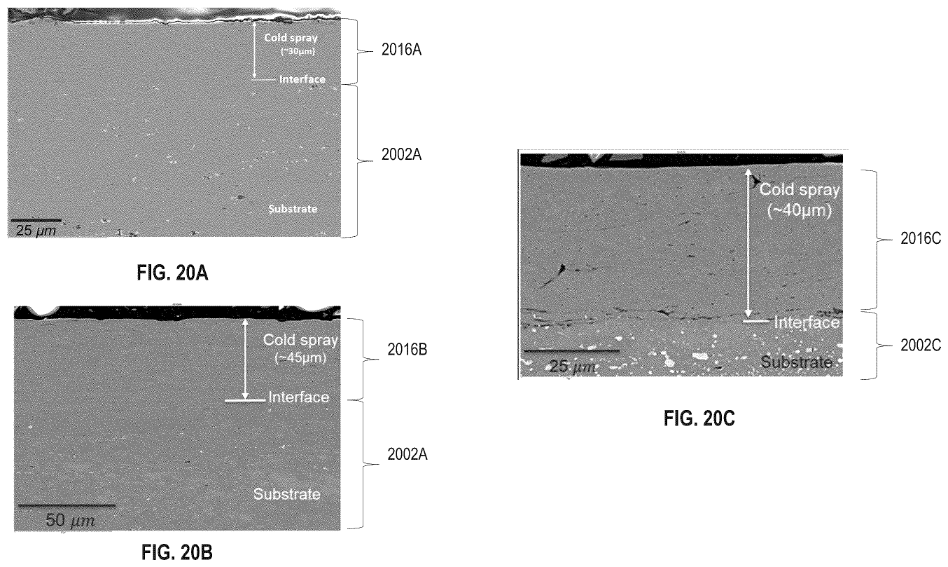

FIGS. 20A-C are images of portions of metal substrates with cold spray coatings according to embodiments and illustrating the good adhesion achieved between the substrates and the cold spray coating. Each of FIGS. 20A-C illustrate the metal substrates after a same rolling operation. FIG. 20A illustrates a 5xxx aluminum alloy substrate 2002A with a cold spray coating 2016A formed with AA6061 alloy particles. FIG. 20B illustrates a 6xxx aluminum alloy substrate 2002A with a cold spray coating 2016A formed with AA6061 alloy particles. FIG. 20C illustrates a 7xxx aluminum alloy substrate 2002A with a cold spray coating 2016A formed with AA6061 alloy particles. In FIG. 20A, the cold spray coating 2016A had a thickness of about 30 μm. In FIG. 20B, the cold spray coating 2016B had a thickness of about 45 μm. In FIG. 20C, the cold spray coating 2016C had a thickness of about 40 μm.

FIG. 21 illustrates an example of a metal substrate 2102A with a cold spray coating according to embodiments compared to a metal substrate 2102B without a cold spray coating. In FIG. 21, both the metal substrates 2102A-B were the same 5xxx aluminum alloy, and the metal substrate 2102A further included a cold spray coating formed with 6xxx aluminum particles. As illustrated by comparing the metal substrate 2102A with the metal substrate 2102B, the metal substrate 2102A with the cold spray coating had a visually brighter appearance compared to the metal substrate 2102B without the cold spray coating.

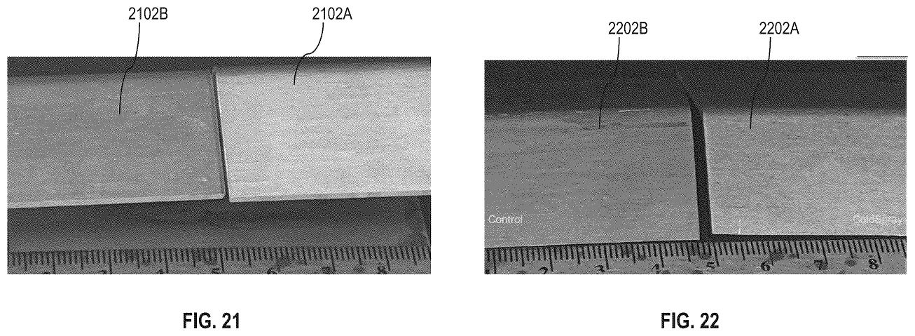

FIG. 22 illustrates an example of a metal substrate 2202A with a cold spray coating according to embodiments compared to a metal substrate 2202B without a cold spray coating. In FIG. 22, both the metal substrates 2202A-B were the same 7xxx aluminum alloy, and the metal substrate 2202A further included a cold spray coating formed with 6xxx aluminum particles. As illustrated by comparing the metal substrate 2202A with the metal substrate 2202B, the metal substrate 2102A with the cold spray coating had a visually brighter appearance compared to the metal substrate 2102B without the cold spray coating.

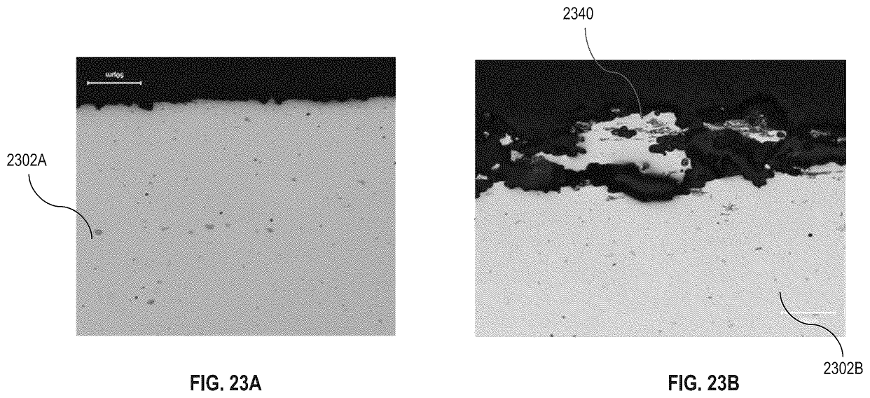

FIGS. 23A-B illustrate corrosion of a metal substrate 2302A with a cold spray coating according to embodiments compared to corrosion a metal substrate 2302B without a cold spray coating. In FIGS. 23A-B, both the metal substrates 2302A-B were the same 7xxx aluminum alloy, and the metal substrate 2302A further included a cold spray coating formed with 6xxx aluminum particles. Corrosion tests for both metal substrates 2302A-B were performed using the ISO 11846B test. As illustrated by comparing the metal substrates 2302A-B, the metal substrate 2302B (without the cold spray coating) generally suffered from corrosion 2340 while the metal substrate 2302A (with the cold spray coating) generally did not.

Various other benefits and advantages may be realized with the techniques described herein, and the aforementioned advantages should not be considered limiting.

As mentioned, the metal products with cold spray coatings described herein can be used a variety of products and may be particularly useful for class A products. In some examples, the metal products may be used in automotive applications and other transportation applications, including aircraft and railway applications, or any other desired application. For example, the disclosed metal products with cold spray coatings can be used to prepare automotive structural parts, such as bumpers, side beams, roof beams, cross beams, pillar reinforcements (e.g., A-pillars, B-pillars, and C-pillars), inner panels, outer panels, side panels, inner hoods, outer hoods, or trunk lid panels. The metal products with cold spray coatings and methods described herein can also be used in aircraft or railway vehicle applications, to prepare, for example, external and internal panels.

The metal products with cold spray coatings and methods described herein can also be used in electronics applications. For example, the metal products with cold spray coatings and methods described herein can be used to prepare housings for electronic devices, including mobile phones and tablet computers. In some examples, the metal products with cold spray coatings can be used to prepare housings for the outer casing of mobile phones (e.g., smart phones), tablet bottom chassis, and other portable electronics.

### Illustrations

A collection of exemplary embodiments is provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A method of processing a metal substrate, the method comprising: additively depositing metal particles on the metal substrate by cold spraying the metal particles to generate a cold spray coating adhered to the metal substrate; and rolling the metal substrate having the cold spray coating with a rolling mill.

Illustration 2. The method of any preceding or subsequent illustrations or combination of illustrations, wherein the metal substrate comprises a continuously cast metal product or an ingot formed from a direct chill casting process.

Illustration 3. The method of any preceding or subsequent illustrations or combination of illustrations, wherein additively depositing the metal particles to generate the cold spray coating comprises controlling the deposition of the metal particles such that a thickness of the cold spray coating is from 30-200 μm, inclusive.

Illustration 4. The method of any preceding or subsequent illustrations or combination of illustrations, wherein controlling the deposition of the metal particles comprises controlling the deposition of the metal particles such that the thickness is from 60-100 μm, inclusive.

Illustration 5. The method of any preceding or subsequent illustrations or combination of illustrations, wherein additively depositing the metal particles to generate the cold spray coating comprises additively depositing the metal particles in a direction perpendicular to a casting direction of the metal substrate.

Illustration 6. The method of any preceding or subsequent illustrations or combination of illustrations, further comprising heating the metal substrate before cold spraying the metal substrate.

Illustration 7. The method of any preceding or subsequent illustrations or combination of illustrations, wherein heating the metal substrate comprises at least one of: using residual heat from an upstream operation to heat the metal substrate; or heating the metal substrate with a dedicated heater.

Illustration 8. The method of any preceding or subsequent illustrations or combination of illustrations, wherein the metal substrate comprises at least one of a 5xxx series aluminum alloy metal substrate, a 6xxx series aluminum alloy metal substrate, or a 7xxx series aluminum alloy metal substrate, and wherein the metal particles of the cold spray coating comprise at least one of a 5xxx series aluminum alloy, a 6xxx series aluminum alloy, or a 7xxx series aluminum alloy.

Illustration 9. The method of any preceding or subsequent illustrations or combination of illustrations, wherein depositing the metal particles on the metal substrate to generate the cold spray coating comprises controlling the deposition of the metal such that a thickness of the cold spray coating is less than a thickness of the metal substrate.

Illustration 10. A method of processing a metal substrate, the method comprising: rolling the metal substrate with a rolling mill; and additively depositing metal particles on the rolled metal substrate by cold spraying the metal particles to generate a cold spray coating adhered to the rolled metal substrate.

Illustration 11. The method of any preceding or subsequent illustrations or combination of illustrations, wherein rolling the metal substrate comprises hot rolling the metal substrate.

Illustration 12. The method of any preceding or subsequent illustrations or combination of illustrations, wherein additively depositing the metal particles to generate the cold spray coating comprises controlling the deposition of the metal particles such that a thickness of the cold spray coating is from 30-200 μm, inclusive.

Illustration 13. The method of any preceding or subsequent illustrations or combination of illustrations, wherein controlling the deposition of the metal particles comprises controlling the deposition of the metal particles such that the thickness is from 60-100 μm, inclusive.

Illustration 14. The method of any preceding or subsequent illustrations or combination of illustrations, wherein additively depositing the metal particles to generate the cold spray coating comprises additively depositing the metal particles across the metal substrate in a direction perpendicular to a casting direction of the metal substrate.

Illustration 15. The method of any preceding or subsequent illustrations or combination of illustrations, wherein the metal substrate comprises at least one of a 5xxx series aluminum alloy metal substrate, a 6xxx series aluminum alloy metal substrate, or a 7xxx series aluminum alloy metal substrate, and wherein the metal particles of the cold spray coating comprise a 6xxx series aluminum alloy.

Illustration 16. The method of any preceding or subsequent illustrations or combination of illustrations, wherein depositing the metal particles on the metal substrate to generate the cold spray coating comprises controlling the deposition of the metal particles such that a thickness of the cold spray coating is less than a thickness of the metal substrate.

Illustration 17. The method of any preceding or subsequent illustrations or combination of illustrations, further comprising heating the metal substrate before cold spraying, wherein heating the metal substrate comprises at least one of: using residual heat from an upstream operation to heat the metal substrate; or heating the metal substrate with a dedicated heater.

Illustration 18. A method of processing a metal substrate, the method comprising: receiving the metal substrate at a cold spray system, wherein the metal substrate is a heated metal substrate; and additively depositing metal particles on the metal substrate by cold spraying the metal particles to generate a cold spray coating adhered to the metal substrate.

Illustration 19. The method of any preceding or subsequent illustrations or combination of illustrations, wherein receiving the metal substrate comprises receiving a continuously cast metal substrate or an ingot formed via direct chill casting.

Illustration 20. The method of any preceding or subsequent illustrations or combination of illustrations, wherein additively depositing the metal particles to generate the cold spray coating comprises additively depositing the metal particles across a width of the metal substrate and controlling the deposition of the metal particles such that a thickness of the cold spray coating is less than a thickness of the metal substrate.

Illustration 21. The method of any preceding or subsequent illustrations or combination of illustrations, wherein additively depositing the metal particles to generate the cold spray coating comprises controlling the deposition of the metal particles such that a thickness of the cold spray coating is from 30-200 μm, inclusive.

Illustration 22. The method of any preceding or subsequent illustrations or combination of illustrations, further comprising heating the metal substrate before receiving the metal substrate at the cold spray system.

Illustration 23. The method of any preceding or subsequent illustrations or combination of illustrations, wherein the metal substrate is heated using at least one of residual heat from an upstream operation to heat the metal substrate or a dedicated heater for heating the metal substrate before additively depositing the metal particles.

Illustration 24. A metal processing system comprising: a cold spray system configured to additively deposit metal particles on a metal substrate by cold spraying the metal particles to generate a cold spray coating adhered to the metal substrate; and a rolling mill downstream from the cold spray system and configured to roll the metal substrate having the cold spray coating.

Illustration 25. The metal processing system of any preceding or subsequent illustrations or combination of illustrations, further comprising a continuous casting device upstream from the cold spray system and configured to cast the metal substrate.

Illustration 26. The metal processing system of any preceding or subsequent illustrations or combination of illustrations, wherein the rolling mill is a hot rolling mill.

Illustration 27. The metal processing system of any preceding or subsequent illustrations or combination of illustrations, wherein the cold spray system is configured to additively deposit the metal particles on the metal substrate across a width of the metal substrate.

Illustration 28. The metal processing system of any preceding or subsequent illustrations or combination of illustrations, further comprising a controller configured to control the cold spray system such that a thickness of the cold spray coating is from 30-200 μm, inclusive.

Illustration 29. The metal processing system of any preceding or subsequent illustrations or combination of illustrations, wherein the controller is configured to control the cold spray system by controlling at least one of a linear speed of a nozzle of the cold spray system or a powder feed rate of the metal particles to be deposited as the cold spray coating.

Illustration 30. A metal processing system comprising: a cold spray system configured to additively deposit metal particles on a metal substrate by cold spraying the metal particles to generate a cold spray coating adhered to the metal substrate; and a rolling mill upstream from the cold spray system and configured to roll the metal substrate prior to the deposition of the metal particles by the cold spray system.

Illustration 31. The metal processing system of any preceding or subsequent illustrations or combination of illustrations, further comprising a controller configured to control the cold spray system such that a thickness of the cold spray coating is from 30-200 μm, inclusive.

Illustration 32. The metal processing system of any preceding or subsequent illustrations or combination of illustrations, wherein the controller is configured to control the cold spray system by controlling at least one of a linear speed of a nozzle of the cold spray system or a powder feed rate of the metal particles to be deposited as the cold spray coating.

Illustration 33. A metal processing system comprising: a cold spray system configured to receive a heated metal substrate, the cold spray system configured to additively deposit metal particles on the heated metal substrate by cold spraying the metal particles to generate a cold spray coating adhered to the metal substrate.

Illustration 34. The metal processing system of any preceding or subsequent illustrations or combination of illustrations, further comprising a rolling mill downstream from the cold spray system and configured to roll the metal substrate having the cold spray coating.

Illustration 35. The metal processing system of any preceding or subsequent illustrations or combination of illustrations, wherein the cold spray system is configured to additively deposit the metal particles on the metal substrate across a width of the metal substrate.

Illustration 36. The metal processing system of any preceding or subsequent illustrations or combination of illustrations, further comprising a controller configured to control the cold spray system such that a thickness of the cold spray coating is from 30-200 μm, inclusive.

Illustration 37. The metal processing system of any preceding or subsequent illustrations or combination of illustrations, wherein the controller is configured to control the cold spray system by controlling at least one of a linear speed of a nozzle of the cold spray system or a powder feed rate of the metal particles to be deposited as the cold spray coating.

Illustration 38. The metal processing system of any preceding or subsequent illustrations or combination of illustrations, wherein the cold spray system is configured to receive the metal substrate at a temperature ranging from about 400° C. to about 500° C.

Illustration 39. The metal processing system of any preceding or subsequent illustrations or combination of illustrations, further comprising at least one piece of equipment upstream from the cold spray system and configured to provide at least residual heat to the metal substrate.

Illustration 40. The metal processing system of any preceding or subsequent illustrations or combination of illustrations, wherein the at least one piece of equipment comprises at least one of a casting device, a warm or hot rolling mill, a continuous annealing solution heat treatment system, or a heater.

Illustration 41. A metal product formed by the method of any preceding or subsequent illustrations or combination of illustrations.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. In the figures and the description, like numerals are intended to represent like elements. As used herein, the meaning of “a,” “an,” and “the” includes singular and plural references unless the context clearly dictates otherwise.

In this description, reference is made to alloys identified by AA numbers and other related designations, such as “series” or “7xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

As used herein, a plate generally has a thickness of greater than about 15 mm. For example, a plate may refer to an aluminum product having a thickness of greater than about 15 mm, greater than about 20 mm, greater than about 25 mm, greater than about 30 mm, greater than about 35 mm, greater than about 40 mm, greater than about 45 mm, greater than about 50 mm, or greater than about 100 mm.

As used herein, a shate (also referred to as a sheet plate) generally has a thickness of from about 4 mm to about 15 mm. For example, a shate may have a thickness of about 4 mm, about 5 mm, about 6 mm, about 7 mm, about 8 mm, about 9 mm, about 10 mm, about 11 mm, about 12 mm, about 13 mm, about 14 mm, or about 15 mm.

As used herein, a sheet generally refers to an aluminum product having a thickness of less than about 4 mm. For example, a sheet may have a thickness of less than about 4 mm, less than about 3 mm, less than about 2 mm, less than about 1 mm, less than about 0.5 mm, or less than about 0.3 mm (e.g., about 0.2 mm).

As used herein, terms such as “cast metal product,” “cast product,” “cast aluminum alloy product,” and the like are interchangeable and refer to a product produced by direct chill casting (including direct chill co-casting), semi-continuous casting, continuous casting (including, for example, by use of a twin belt caster, a twin roll caster, a block caster, or any other continuous caster), electromagnetic casting, hot top casting, or any other casting method.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g., 1 to 6.1, and ending with a maximum value of 10 or less, e.g., 5.5 to 10. Unless stated otherwise, the expression “up to” when referring to the compositional amount of an element means that element is optional and includes a zero percent composition of that particular element. Unless stated otherwise, all compositional percentages are in weight percent (wt. %).

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

1. A method of processing a metal substrate, the method comprising:
additively depositing metal particles on the metal substrate by cold spraying the metal particles to generate a cold spray coating adhered to the metal substrate; and
at least one of:
rolling the metal substrate having the cold spray coating with a rolling mill; or
rolling the metal substrate with a rolling mill before additively depositing the metal particles on the metal substrate.

2. (canceled)

3. The method of claim 1, wherein additively depositing the metal particles to generate the cold spray coating comprises controlling the deposition of the metal particles such that a thickness of the cold spray coating is from 30-200 μm, inclusive.

4. (canceled)

5. The method of claim 1, wherein additively depositing the metal particles to generate the cold spray coating comprises additively depositing the metal particles in a direction perpendicular to a casting direction of the metal substrate.

6. The method of claim 1, further comprising heating the metal substrate before cold spraying the metal substrate, wherein heating the metal substrate comprises at least one of:
using residual heat from an upstream operation to heat the metal substrate; or
heating the metal substrate with a dedicated heater.

7. (canceled)

8. (canceled)

9. The method of claim 1, wherein depositing the metal particles on the metal substrate to generate the cold spray coating comprises controlling the deposition of the metal such that a thickness of the cold spray coating is less than a thickness of the metal substrate.

10.-14. (canceled)

15. The method of claim 1, wherein the metal substrate comprises at least one of a 5xxx series aluminum alloy metal substrate, a 6xxx series aluminum alloy metal substrate, or a 7xxx series aluminum alloy metal substrate, and wherein the metal particles of the cold spray coating comprise a 6xxx series aluminum alloy.

16. (canceled)

17. (canceled)

18. A method of processing a metal substrate, the method comprising:
receiving the metal substrate at a cold spray system, wherein the metal substrate is a heated metal substrate; and
additively depositing metal particles on the metal substrate by cold spraying the metal particles to generate a cold spray coating adhered to the metal substrate.

19. The method of claim 18, wherein receiving the metal substrate comprises receiving a continuously cast metal substrate or an ingot formed via direct chill casting.

20. The method of claim 18, wherein additively depositing the metal particles to generate the cold spray coating comprises additively depositing the metal particles across a width of the metal substrate and controlling the deposition of the metal particles such that a thickness of the cold spray coating is less than a thickness of the metal substrate.

21. The method of claim 18, wherein additively depositing the metal particles to generate the cold spray coating comprises controlling the deposition of the metal particles such that a thickness of the cold spray coating is from 30-200 μm, inclusive.

22. The method of claim 18, further comprising heating the metal substrate before receiving the metal substrate at the cold spray system, wherein the metal substrate is heated using at least one of residual heat from an upstream operation to heat the metal substrate or a dedicated heater for heating the metal substrate before additively depositing the metal particles.

23. (canceled)

24. A metal processing system comprising:
a cold spray system configured to additively deposit metal particles on a metal substrate by cold spraying the metal particles to generate a cold spray coating adhered to the metal substrate; and
at least one of:
a downstream rolling mill downstream from the cold spray system and configured to roll the metal substrate having the cold spray coating; or
an upstream rolling mill upstream from the cold spray system and configured to roll the metal substrate prior to the deposition of the metal particles by the cold spray system.

25. (canceled)

26. (canceled)

27. The metal processing system of claim 24, wherein the cold spray system is configured to additively deposit the metal particles on the metal substrate across a width of the metal substrate.

28. The metal processing system of claim 24, further comprising a controller, wherein at least one of:
the controller is configured to control the cold spray system such that a thickness of the cold spray coating is from 30-200 μm, inclusive; or
the controller is configured to control the cold spray system by controlling at least one of a linear speed of a nozzle of the cold spray system or a powder feed rate of the metal particles to be deposited as the cold spray coating.

29.-32. (canceled)

33. The metal processing system of claim 24, wherein the cold spray system is configured to receive the metal substrate after the metal substrate is heated.

34. (canceled)

35. (canceled)

36. The metal processing system of claim 24, further comprising a controller configured to control the cold spray system such that a thickness of the cold spray coating is from 30-200 μm, inclusive.

37. The metal processing system of claim 36, wherein the controller is configured to control the cold spray system by controlling at least one of a linear speed of a nozzle of the cold spray system or a powder feed rate of the metal particles to be deposited as the cold spray coating.

38. The metal processing system of claim 24, wherein the cold spray system is configured to receive the metal substrate at a temperature ranging from about 400° C. to about 500° C.

39. The metal processing system of claim 38, further comprising at least one piece of equipment upstream from the cold spray system and configured to provide at least residual heat to the metal substrate.

40. The metal processing system of claim 39, wherein the at least one piece of equipment comprises at least one of a casting device, a warm or hot rolling mill, a continuous annealing solution heat treatment system, or a heater.

41. (canceled)
